(19) United States
(12) Patent Application Publication
(10) Pub. No.: US 2026/0151914 A1
(43) Pub. Date: Jun. 4, 2026

(54) ROBOT APPARATUS AND METHOD FOR CONTROLLING THE SAME

(71) Applicant: SAMSUNG ELECTRONICS CO., LTD., Suwon-si (KR)

(72) Inventors: Dongsik YUN, Suwon-si (KR); Boseok MOON, Suwon-si (KR)

(73) Assignee: SAMSUNG ELECTRONICS CO., LTD., Suwon-si (KR)

(21) Appl. No.: 19/370,012

(22) Filed: Oct. 27, 2025

Related U.S. Application Data
(63) Continuation of application No. PCT/KR2025/014282, filed on Sep. 12, 2025.

(30) Foreign Application Priority Data
Dec. 3, 2024 (KR) 10-2024-0177905

(51) Int. Cl. B25J 9/16

(52) U.S. Cl. CPC B25J 9/1694; B25J 9/1612; B25J 9/1661

(57) ABSTRACT

A robot includes: a body; robot arms on the body; a sensor detachably connected to the body; memory storing at least one instruction; and at least one processor configured to execute the at least one instruction, wherein the at least one instruction, when executed by the at least one processor individually or collectively, causes the robot apparatus to: identify a target based on a sensing value of the sensor; perform a task related to the target using at least one of the robot arms; based on identifying that the target is occluded by an object, control a first robot arm among the robot arms to grip and separate the sensor from the body and to change a position and a sensing direction of the sensor; and identify a status of the target and the object based on a sensing value of the sensor obtained at the changed position.

### CROSS-REFERENCE TO RELATED APPLICATIONS

This application is a by-pass continuation of International Application No. PCT/KR2025/014282, filed on September 12, 2025, which is based on and claims priority to Korean Patent Application No. 10-2024-0177905, filed on December 03, 2024, in the Korean Intellectual Property Office, the disclosures of which are incorporated by reference herein in their entireties.

### BACKGROUND

### 1. Field

The disclosure relates to a robot apparatus and a method for controlling the same, and more particularly, to a robot apparatus including a detachable robot head and a method for controlling the same.

### 2. Description of Related Art

With technological advancement, robot technology has been utilized in various fields to replace human labor. In particular, robot apparatuses have been developed in fields requiring delicate and sophisticated work, such as factories, construction, medical sites, and aerospace.

A robot apparatus may use at least one sensor for its operation. In the case of a general robot apparatus, a sensor is attached to a robot head side and used.

When a robot apparatus of the related art operates in a narrow space and uses only a sensor attached to the robot head, there are cases in which a target cannot be accurately identified due to an occlusion. For example, the target may be obscured by surrounding objects.

### SUMMARY

According to an aspect of the disclosure, a robot apparatus includes: a main body; a plurality of robot arms on the main body; a sensor detachably connected to the main body; memory storing at least one instruction; and at least one processor configured to execute the at least one instruction, wherein the at least one instruction, when executed by the at least one processor individually or collectively, causes the robot apparatus to: identify a target based on a sensing value of the sensor; perform a task related to the target using at least one of the plurality of robot arms; based on identifying that the target is occluded by an object, control a first robot arm among the plurality of robot arms to grip and separate the sensor from the main body and to change a position and a sensing direction of the sensor; and identify a status of the target and the object based on a sensing value of the sensor obtained at the changed position.

The at least one instruction, when executed by the at least one processor individually or collectively, may further cause the robot apparatus to control a second robot arm, among the plurality of robot arms, to grip the target based on the status of the target and the object.

The at least one instruction, when executed by the at least one processor individually or collectively, may further cause the robot apparatus to: mount the sensor on the main body; and control the first robot arm to grip the target based on the status of the target and the object.

The at least one instruction, when executed by the at least one processor individually or collectively, may further cause the robot apparatus to: based on the object interfering with an ability of the robot apparatus to grip the target, grip and move the object using at least one of the plurality of robot arms before gripping the target.

The at least one instruction, when executed by the at least one processor individually or collectively, may further cause the robot apparatus to: based on the object interfering with an ability of the robot apparatus to grip the target, grip and move the object using at least one of the plurality of robot arms before gripping the target.

The main body may include: a robot body; a driver below the robot body; and a robot head above the robot body, and wherein the plurality of robot arms are coupled to sides of the robot body, and the sensor is on the robot head.

The robot head may further include: a connection portion configured to connect to the sensor; and a reel cable connected to the sensor, and wherein the reel cable is extendable based on the sensor being separated from the main body.

The robot head may include a first interface configured to connect to the sensor, wherein an end effector of at least one first robot arm among the plurality of robot arms includes a second interface configured to connect to the sensor, and the at least one instruction, when executed by the at least one processor individually or collectively, may further cause the robot apparatus to, based on the occlusion being identified while the sensor is coupled to the robot head through the first interface, control the first robot arm to separate the sensor from the first interface and to mount the sensor on the second interface.

The at least one instruction, when executed by the at least one processor individually or collectively, may further cause the robot apparatus to: control the first robot arm to sequentially move the sensor to a plurality of positions facing the target, and identify a characteristic of the target and a characteristic of the object by combining sensing values obtained at the plurality of positions.

According to an aspect of the disclosure, a method of controlling a robot apparatus includes: based on identifying that a target is occluded by an object, controlling a first robot arm among a plurality of robot arms of the robot apparatus to grip a sensor of the robot apparatus and to separate the sensor from a main body of the robot apparatus; moving the first robot arm to change a position and a sensing direction of the sensor; identifying a status of the target and the object based on a sensing value, wherein the sensing value is obtained by the sensor at a changed position; and gripping the target using at least one of the plurality of robot arms.

The gripping the target using at least one of the plurality of robot arms may include: controlling a second robot arm, among the plurality of robot arms, to grip the target while the sensor is gripped by the first robot arm and is sensing the target.

The gripping the target using at least one of the plurality of robot arms may include: based on the status of the target and the object being identified based on the sensing value sensed by the sensor at the changed position, controlling the first robot arm to re-mount the sensor on the main body; and controlling the first robot arm to grip the target.

The method may further include: based on the object interfering with an ability of the robot apparatus to grip the target, gripping and moving the object using at least one of the plurality of robot arms before gripping the target.

The method may further include: based on the object interfering with an ability of the robot apparatus to grip the target, gripping and moving the object using at least one of the plurality of robot arms before gripping the target.

The controlling the first robot arm among the plurality of robot arms to grip the sensor and to separate the sensor from the main body may include, based on identifying that the target is occluded while the sensor is connected to a first interface of the robot head of the robot apparatus, controlling the first robot arm to separate the sensor from the first interface on a robot head of robot apparatus and to connect the sensor to a second interface on an end effector of the first robot arm.

The moving the first robot arm to change the position and the sensing direction of the sensor may include controlling the first robot arm to sequentially move the sensor to a plurality of positions facing the target.

The identifying the status of the target and the object may include identifying a characteristic of the target and a characteristic of the object by combining the sensing values sensed at the plurality of positions and directions.

According to an aspect of the disclosure, a non-transitory computer readable medium has instructions stored therein, which when executed by at least one processor cause the at least one processor to execute a method of controlling a robot apparatus, the method including: based on identifying that a target is occluded by an object, controlling a first robot arm among a plurality of robot arms of the robot apparatus to grip a sensor of the robot apparatus and to separate the sensor from a main body of the robot apparatus; moving the first robot arm to change a position and a sensing direction of the sensor; identifying a status of the target and the object based on a sensing value, wherein the sensing value is obtained by the sensor at a changed position; and gripping the target using at least one of the plurality of robot arms.

With regard to the method executed based on the instructions stored in the non-transitory computer readable medium, the gripping the target using at least one of the plurality of robot arms may include: controlling a second robot arm, among the plurality of robot arms, to grip the target while the sensor is gripped by the first robot arm and is sensing the target.

With regard to the method executed based on the instructions stored in the non-transitory computer readable medium, the gripping the target using at least one of the plurality of robot arms may include: based on the status of the target and the object being identified based on the sensing value sensed by the sensor at the changed position, controlling the first robot arm to re-mount the sensor on the main body; and controlling the first robot arm to grip the target.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a diagram illustrating a robot apparatus according to at least one or more embodiments of the present disclosure;

FIG. 2 is a diagram illustrating a robot apparatus according to at least one or more embodiments of the present disclosure;

FIG. 3 is a diagram illustrating a robot apparatus including a reel cable according to at least one or more embodiments of the present disclosure;

FIG. 4 is a diagram illustrating a robot apparatus including a neck according to at least one or more embodiments of the present disclosure;

FIG. 5 is a block diagram illustrating a robot apparatus according to at least one or more embodiments of the present disclosure;

FIGS. 6A, 6B, and 6C, are diagrams illustrating a robot apparatus changing a position and a sensing direction of a sensor according to at least one or more embodiments of the present disclosure;

FIGS. 7A and 7B are diagrams illustrating a method for gripping a target according to at least one or more embodiments of the present disclosure; and

FIGS. 8 to 10 are flowcharts of methods of operating a robot apparatus according to at least one or more embodiments of the present disclosure.

### DETAILED DESCRIPTION

Hereinafter, one or more embodiments are described in more detail with reference to the accompanying drawings. The embodiments described in the specification may be modified in various manners. A specific embodiment may be shown in the drawings and described in detail in a detailed description. However, the specific embodiment disclosed in the accompanying drawings is provided only to assist in easy understanding of the one or more embodiments. Therefore, it should be appreciated that one or more embodiments of the disclosure and the terms used herein are not intended to limit the technological features set forth herein to particular embodiments of the disclosure and include various changes, equivalents, or replacements for a corresponding embodiment.

The singular form of a noun corresponding to an item may include one or more items unless clearly referred to contextually differently.

As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

The term “and/or” includes any component of a plurality of related described components or a combination of a plurality of related described components.

As used herein, such terms as “1^{st}” and “2^{nd}”, or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with”, “coupled to”, “connected with”, or “connected to” another element (e.g., a second element), it refers to that the element may be coupled with the other element directly (e.g., wiredly), wirelessly, or via a third element.

In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

When a component is “connected,” “coupled,” “supported,” or “in contact” with another component, this includes not only a case in which the components are directly connected, coupled, supported, or in contact, but also a case in which the components are indirectly connected, coupled, supported, or in contact through a third component.

In the disclosure, the expression “the same” not only includes complete sameness but also a difference in consideration of a processing error range.

When it is mentioned that a component is located “on” another component, this mention includes a case in which an element comes in contact with another element and a case in which still another element is present between both elements.

In the following description, like reference numerals refer to like elements throughout the specification. Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Hereinafter, a robot apparatus 1 according to one or more embodiments of the disclosure are described in detail with reference to the accompanying drawings.

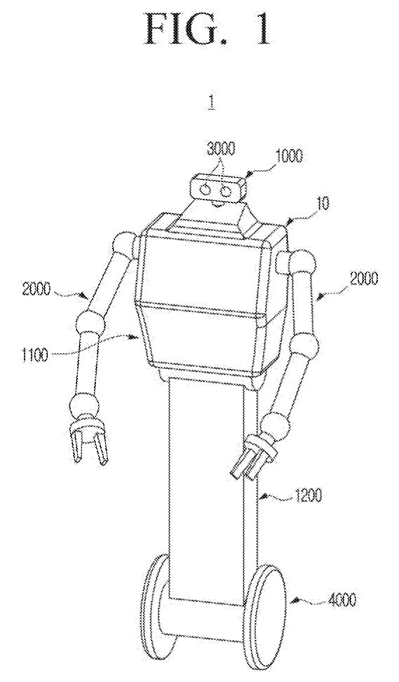

FIG. 1 is a diagram illustrating a robot apparatus 1 according to at least one or more embodiments of the present disclosure.

In FIG. 1, the robot apparatus 1 may include a main body 10, a plurality of robot arms 2000, a sensor 3000, and a driver 4000.

The main body 10 is a component including devices for managing the overall operation of the robot apparatus 1. The main body 10 is a device forming an outer appearance of the robot apparatus 1. In FIG. 1, the main body 10 may include a robot head 1000, a robot body 1100, and the driver 4000.

The robot head 1000 may be disposed above the robot body 1100. The robot head 1000 may include a sensor 3000. The robot head 1000 may detect a surrounding environment based on a sensing value of the sensor 3000. The sensor 3000 may be formed integrally with the robot head 1000 or may be formed in a form disposed inside the robot head 1000. The robot head 1000 may be detachably attached to the main body 10.

The robot body 1100 may be disposed below the robot head 1000. The robot body 1100 may be disposed in the center of the robot apparatus 1. The robot body 1100 is a device that protects various main components of the robot apparatus 1 on the inside. The robot body 1100 may have a plurality of robot arms 2000 disposed on both sides of the robot body 1100. The robot body 1100 may include a robot leg 1200. In FIG. 1, the robot leg 1200 is a member that connects the driver 4000 and the robot body 1100. However, the disclosure is not limited thereto, and the robot leg 1200 may be formed in various shapes according to a user's intention. For example, if a manufacturer of the robot apparatus 1 manufactures the robot apparatus 1 as a humanoid robot, the robot leg 1200 may be formed in a shape including two legs. If a manufacturer manufactures the robot apparatus 1 as a quadruped walking robot, the robot leg 1200 may be formed in a shape including four legs.

The driver 4000 may be disposed below the robot body 1100. The driver 4000 may move the robot apparatus 1 to a specific position by power of a built-in motor. In FIG. 1, the driver 4000 is formed as a wheel, but the disclosure is not necessarily limited thereto. For example, if the robot apparatus 1 is a humanoid robot, the driver 4000 may be omitted, and the robot may move in a walking manner by sequentially driving the two separated robot legs 1200. Even if the robot apparatus 1 is a quadruped walking robot, the driver 4000, such as a wheel, may be omitted, and the robot leg 1200 may replace the role of the driver.

The sensor 3000 may be arranged in front of the robot head 1000. The sensor 3000 may be disposed in a form that may be attached to or detached from the main body 10 or the robot head 1000. In FIG. 1, two sensors 3000 are arranged in front of the robot head 1000, but the disclosure is not limited thereto, and the sensor 3000 may be formed as a single sensor or as a plurality of three or more sensors.

A plurality of robot arms 2000 may be disposed on the main body 10. Specifically, a plurality of robot arms 2000 may be coupled to sides of the robot body 1100. The plurality of robot arms 2000 are configured to an end effector to a specific position by moving each of a plurality of joints. The plurality of robot arms 2000 may be formed integrally with the main body 10 or may exist as modules independent of the main body 10 and be formed in a form assembled to the main body 10.

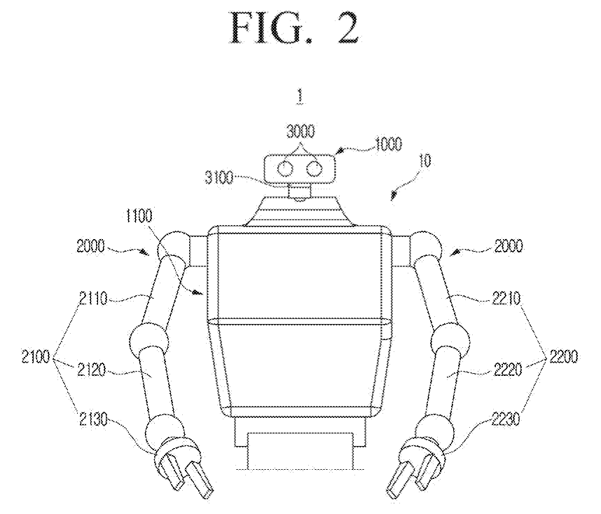

FIG. 2 is a diagram illustrating the robot apparatus 1 according to at least one or more embodiments of the present disclosure.

In FIG. 2, the plurality of robot arms 2000 may include a first robot arm 2100 and a second robot arm 2200. The first robot arm 2100 may include a plurality of first joints 2110 and 2120 and a first end effector 2130. The second robot arm 2200 may include a plurality of second joints 2210 and 2220 and a second end effector 2230.

The plurality of first joints 2110 and 2120 and the plurality of second joints 2210 and 2220 may move in various manners around each axis. The plurality of first joints 2110 and 2120 and the plurality of second joints 2210 and 2220 are all illustrated as I-shaped modules in FIG. 2, but are not necessarily limited thereto and may be formed as various types of modules, such as L-shaped modules. The plurality of robot arms 2000 are not limited to the first robot arm 2100 and the second robot arm 2200 and may include three or more different robot arms.

The first end effector 2130 and the second end effector 2230 may be assembled to one side of the plurality of first joints 2110 and 2120 and the plurality of second joints 2210 and 2220, respectively. The first end effector 2130 and the second end effector 2230 are modules through which the robot apparatus 1 directly interacts with an object or an environment in order to perform a specific task.

Depending on the type or shape of the end effectors, the robot apparatus 1 may perform various tasks, such as gripping an object, tapping, or drilling a hole. In one or more embodiments of the present disclosure, a case in which the task of gripping an object is performed is illustrated and described.

The first end effector 2130 and the second end effector 2230 may be capable of gripping a specific object. The first end effector 2130 and the second end effector 2230 may include a gripper. The first end effector 2130 and the second end effector 2230 may grip an object disposed between the grippers through a driving motor and perform various operations, such as lifting an object or moving a position of an object.

The robot head 1000 may be formed integrally with the sensor 3000. The robot head 1000 may include the sensor 3000 and a detachable connection portion 3100. The connection portion 3100 is an intermediate member that may connect or separate the robot head 1000 and the main body 10. The connection portion 3100 may include a magnetic guide. Through this, the connection portion 3100 may stably couple the robot head 1000 and the main body. However, the connection portion 3100 is not limited thereto and may be implemented in various forms. For example, the connection portion 3100 may include an insertion region into which the sensor 3000 may be inserted. The sensor 3000 may be manufactured in a size and shape corresponding to the insertion region and may be inserted into or separated from the insertion region. Alternatively, the connection portion 3100 may be provided with at least one recess into which at least one protrusion provided on the sensor 3000 may be inserted. In addition, the connection portion 3100 and the sensor 3000 may be connected or separated in various forms.

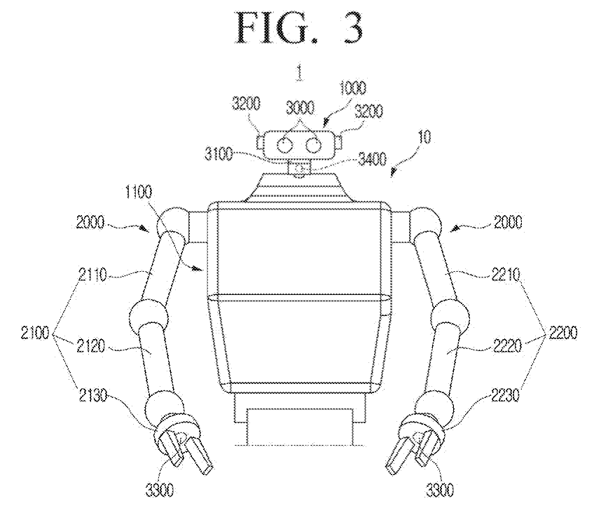

FIG. 3 is a diagram illustrating the robot apparatus 1 including a reel cable 3400 according to at least one or more embodiments of the present disclosure.

The robot apparatus 1 may include a first interface 3200 and a second interface 3300. Based on an occlusion being identified while the sensor 3000 is coupled to the robot head 1000 via the first interface 3200, the robot apparatus 1 may control the first robot arm 2100 or the second robot arm 2200 to separate the sensor 3000 of the robot head 1000 from the first interface 3200 and mount the sensor 3000 on the second interface 3300 provided on the first robot arm 2100 or the second robot arm 2200. In FIG. 3, the second interface 3300 is illustrated as being disposed in a central portion of the first end effector 2130 and the second end effector 2230, but the second interface 3300 not necessarily limited thereto and may be disposed at various positions of the first end effector 2130 and the second end effector 2230. Accordingly, the robot apparatus 1 may operate normally through the first interface 3200 and the second interface 3300 even if the robot head 1000 or the sensor 3000 is separated.

The robot apparatus 1 may include the reel cable 3400. The robot head 1000 may include the reel cable 3400 connected to the sensor 3000. The reel cable 3400 may extend according to the position of the sensor 3000 based on the sensor 3000 being separated from the main body 10. Accordingly, in the robot apparatus 1, the sensor 3000 may operate normally through the reel cable 3400 even if the robot head 1000 or the sensor 3000 is separated.

In FIG. 3, the robot apparatus 1 is illustrated with the first interface 3200, the second interface 3300, and the reel cable 3400 all coupled together, but the disclosure is not limited thereto, and the robot apparatus 1 may be formed in a form including only the first interface 3200 and the second interface 3300 or in a form including only the reel cable 3400.

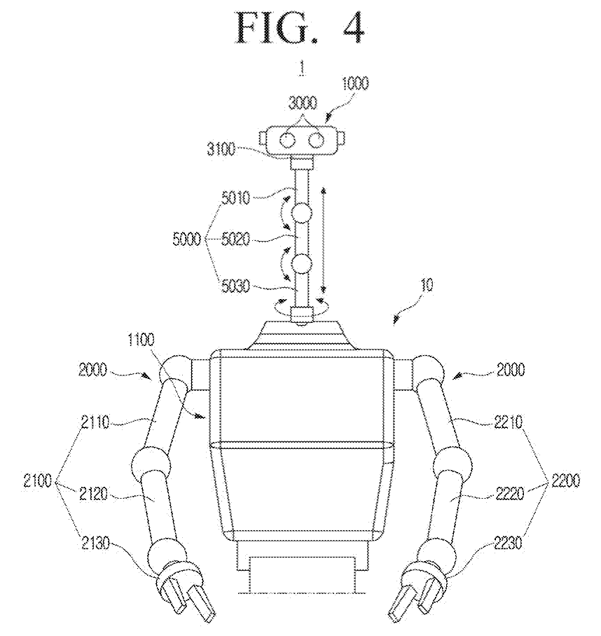

FIG. 4 is a diagram illustrating the robot apparatus 1 including a neck 5000 according to at least one or more embodiments of the present disclosure.

In FIG. 4, the robot apparatus 1 may include the neck 5000. The neck 5000 may be disposed between the main body 10 and the robot head 1000. The neck 5000 may move the robot head 1000 and the sensor 3000 to various positions through a plurality of neck joints 5010, 5020, and 5030. The neck 5000 may include a plurality of neck joints 5010, 5020, and 5030. The plurality of neck joints 5010, 5020, and 5030 may be formed integrally with the main body 10 or may exist as modules independent of the main body 10 and be formed in a form assembled to the main body 10. The plurality of neck joints 5010, 5020, and 5030 may move in various manners around each axis. The plurality of neck joints 5010, 5020, and 5030 are all illustrated as I-shaped modules in FIG. 4, but are not necessarily limited thereto, and may be formed as modules in various shapes, such as L-shaped modules.

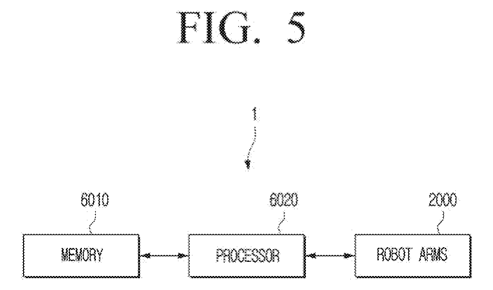

FIG. 5 is a block diagram of the robot apparatus 1 according to at least one or more embodiments of the present disclosure.

The robot apparatus 1 may include a memory 6010, a processor 6020, and a plurality of robot arms 2000.

The memory 6010 is configured to include various programs, commands, and data necessary for the operation of the robot apparatus 1. The memory 6010 may store at least one instruction. In FIG. 5, the memory 6010 is illustrated as being separate from the processor 6020, but without being limited thereto, and the memory 6010 may be implemented as an internal memory, such as read-only memory (ROM) (e.g., an electrically erasable programmable read-only memory (EEPROM)) or a random access memory (RAM) included in the processor 6020.

Alternatively, the memory 6010 may be implemented as a memory embedded in the robot apparatus 1 or as a memory that may be attached or detached to the robot apparatus 1 depending on the purpose of data storage. Specifically, the memory 6010 may be implemented in various forms, such as volatile memory, static RAM (SRAM) or synchronous dynamic RAM (SDRAM), nonvolatile memory (e.g., one time programmable ROM (OTPROM), programmable ROM (PROM), erasable and programmable ROM (EPROM), electrically erasable and programmable ROM (EEPROM), mask ROM, flash ROM, flash memory, hard drive, or solid state drive (SSD), compact flash (CF), secure digital (SD), micro secure digital (microSD), mini secure digital (mini-SD), extreme digital (xD), multi-media card (MMC), etc.

In the present disclosure, the term memory 6010 may be used to refer to a storage unit, a ROM in the processor 6020, a RAM, or a memory card (e.g., a micro SD card, a memory stick) mounted on an electronic device. In FIG. 5, the memory 6010 is illustrated as one memory but may be implemented in various numbers.

The memory 6010 is configured to store at least one instruction, operating system (O/S), program, and data related to the robot apparatus 1.

The memory 6010 is accessed by the processor 6020. In the memory 6010, data reading/recording/modifying/deleting/updating by the processor 6020 may be performed.

Specifically, the memory 6010 may store various information, such as information on an assembly status of each joint of the plurality of robot arms 2000, shape information of the robot head 1000, attachment position information of the first interface 3200, maximum extension distance range information of the reel cable 3400, maximum sensing-available range information of the sensor 3000, driving speed information of the driver 4000, and assembly status information of each joint of the neck 5000, programs, commands, etc. for controlling the operation of the robot apparatus 1 and other devices.

The memory 6010 may store a plurality of pre-trained artificial intelligence models. For example, the artificial intelligence models may be implemented as convolutional neural network (CNN), long short-term memory (LSTM), deep neural network (DNN), recurrent neural network (RNN), restricted Boltzmann machine (RBM), deep belief network (DBN), bidirectional recurrent deep neural network (BRDNN), etc., but are not limited to these examples. These artificial intelligence models are computing systems implemented based on the neural network of the human or animal brain and may also be referred to as learning models, machine learning models, neural network models, deep learning models, etc.

The processor 6020 is a component connected to each component of the robot apparatus 1 and controlling the overall operation of the robot apparatus 1. The processor 6020 may operate according to the execution of at least one instruction. The processor 6020 may be implemented as a digital signal processor (DSP), a microprocessor, a graphics processing unit (GPU) that processes a digital image signal. However, without being limited thereto, the processor 6020 may include one or more of a central processing unit (CPU), a micro controller unit (MCU), a micro processing unit (MPU), a controller, an application processor (AP), a communication processor (CP), an ARM processor or may be defined by the corresponding term. In addition, the processor 6020 may be implemented as a system on chip (SoC), a large scale integration (LSI) with a built-in processing algorithm or may be implemented in the form of an application specific integrated circuit (ASIC), or a field programmable gate array (FPGA).

The processor 6020 may perform at least one of the various operations described above based on an artificial intelligence model. The processor 6020 for executing the artificial intelligence model may be implemented through a combination of software and a general-purpose processor, such as a CPU, an AP, a digital signal processor (DSP), a graphics-only processor, such as a GPU, a vision processing unit (VPU), or an artificial intelligence-only processor, such as an NPU.

Based on being implemented as an artificial intelligence-only processor, the processor 6020 may be designed as a hardware chip, such as an ASIC or an FPGA that is specialized for processing a specific artificial intelligence model.

Based on being implemented as a dedicated processor, the processor 6020 may be implemented to include the memory 6010 for implementing an embodiment of the present disclosure or may be implemented to include a memory processing function for using an external memory. The processor 6020 may be implemented as one or a plurality of processors. In addition, the processor 6020 may individually or collectively perform various operations based on programs, commands, data, etc. stored in the memory 6010.

The processor 6020 may identify a target based on a sensing value of the sensor 3000 and perform a task on the target using at least one of the plurality of robot arms 2000. The processor 6020 may identify whether the target is occluded by a surrounding object.

The presence of an occlusion may be identified in various manners. For example, based on the sensor 3000 including a camera, the processor 6020 may identify the target and surrounding objects in a captured image captured by the camera and identify whether there is an occlusion based on whether there is an overlap and an overlap ratio, etc. Specifically, the processor 6020 divides all pixels in the captured image into a plurality of pixel groups and then extracts pixel representative values of pixels included in each pixel group. The processor 6020 identifies positions of the pixel groups having the pixel representative values that are in a similar range, and based on a plurality of similar pixel groups being located continuously, the processor 6020 identifies that the similar pixel groups form an edge for a single object. The processor 6020 may estimate what kind of object the object is based on a shape of the edge, the pixel values of pixels belonging to the edge, etc., and identify a distance to the object based on the size of the edge.

Based on a target object to be gripped, i.e., a target, being an apple, the processor 6020 may identify an edge forming a round closed loop within the captured image, and based on pixel values included in the closed loop being a color (e.g., red) corresponding to the apple, the target may be identified as being completely sensed. Based on a portion of the target being occluded by a surrounding object, a portion of the edge identified within the captured image is deformed. That is, a portion of the round closed loop becomes distorted inward. The processor 6020 may determine that an occlusion has occurred based on the ratio of the size of the distorted portion to the size of the entire edge being equal to or greater than a certain ratio (e.g., 10 %). The description of the object identification method and the occlusion identification method above is only an example and is not limited thereto.

Based on a determination that an occlusion has occurred, the processor 6020 may control the first robot arm 2100 among the plurality of robot arms 2000 to grip the sensor 3000 of the main body 10 and separate the sensor 3000 from the main body 10 to change the position and sensing direction of the sensor 3000. Here, the processor 6020 is described as controlling the first robot arm 2100 among the plurality of robot arms 2000, but, without being limited thereto, the processor 6020 may control the second robot arm 2200 among the plurality of robot arms 2000 to grip and separate the sensor 3000 of the main body 10 to change the position and sensing direction of the sensor 3000. In the following description, the processor 6020 is described based on controlling the first robot arm 2100 among the plurality of robot arms 2000, but the second robot arm 2200 among the plurality of robot arms 2000 may also be controlled in the same manner as that of the first robot arm 2100. In addition, the control operations of the first robot arm 2100 and the second robot arm 2200 among the plurality of robot arms 2000 may include control operations of the plurality of first joints 2110 and 2120, the plurality of second joints 2210 and 2220, the first end effector 2130, and the second end effector 2230.

Thereafter, the processor 6020 may control the first robot arm 2100 among the plurality of robot arms 2000 to identify the state of the target and surrounding objects based on the sensing value sensed by the sensor 3000 at the changed position.

Based on the state of the target and surrounding objects being identified based on the sensing value sensed by the sensor 3000 at the changed position, the processor 6020 may control the second robot arm 2200, which is another one of the plurality of robot arms 2000, to grip the target. Thereafter, based on the state of the target and surrounding objects being identified based on the sensing value sensed by the sensor 3000 at the changed position, the processor 6020 may mount the sensor 3000 on the main body 10 and control the first robot arm 2100 to grip the target. Thereafter, based on interference occurring with a surrounding object during the process of gripping the target, the processor 6020 may first grip and move the surrounding object using at least one of the plurality of robot arms 2000, and then grip the target. In the present disclosure, the occurrence of interference includes not only a case in which the robot arm or the end effector of the robot arm directly touches the surrounding object during the process of gripping the target, but also a case in which the possibility of touching the surrounding object is equal to or greater than a preset probability. In other words, the occurrence of interference may also include a case of identifying that the robot arm or the end effector of the robot arm will touch a surrounding object if the gripping operation is performed further even before touching the surrounding object.

Based on interference occurring and the second robot arm 2200 among the plurality of robot arms 2000 gripping the sensor 3000 and changing its position, the processor 6020 may control the first robot arm 2100, which is another one of the plurality of robot arms 2000, to grip the target. That is, the processor 6020 may control the first robot arm 2100 and the second robot arm 2200 among the plurality of robot arms 2000 in opposite directions, respectively.

Based on an occlusion being identified while the sensor 3000 is coupled to the robot head 1000 through the first interface 3200, the processor 6020 may control the first robot arm 2100 to separate the sensor 3000 of the robot head 1000 from the first interface 3200 and mount the sensor 3000 on the second interface 3300 provided on the first robot arm 2100.

The processor 6020 may control the first robot arm 2100 to sequentially move the sensor 3000 to a plurality of positions facing the target in different directions based on the target. The position for sensing the target refers to a position facing the target. For example, based on the sensor 3000 being a camera, the processor 6020 may move the camera near the target and then adjust the direction so that the lens of the camera faces the target.

The processor 6020 may identify the characteristics of the target and the characteristics of objects surrounding the target by combining the entire sensing values sensed at a plurality of positions and directions.

In the above description, the processor 6020 may control each of the first robot arm 2100 and the second robot arm 2200. At this time, the task that the first robot arm 2100 may perform may also be performed by the second robot arm 2200, and the task that the second robot arm 2200 may perform may also be performed by the first robot arm 2100. The processor 6020 may control the first robot arm 2100 and the second robot arm 2200 so that the control operation of the first robot arm 2100 and the control operation of the second robot arm 2200 among the plurality of robot arms 2000 are switched in order to operate.

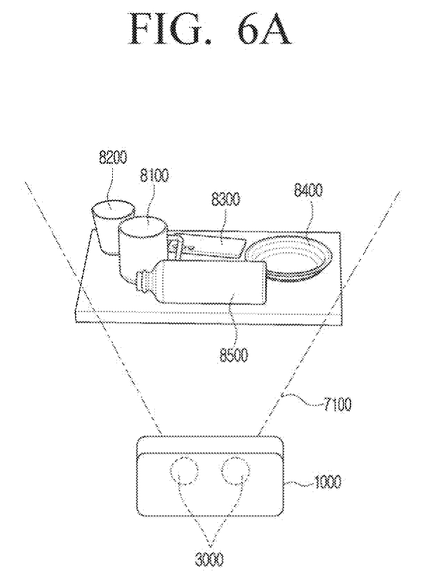

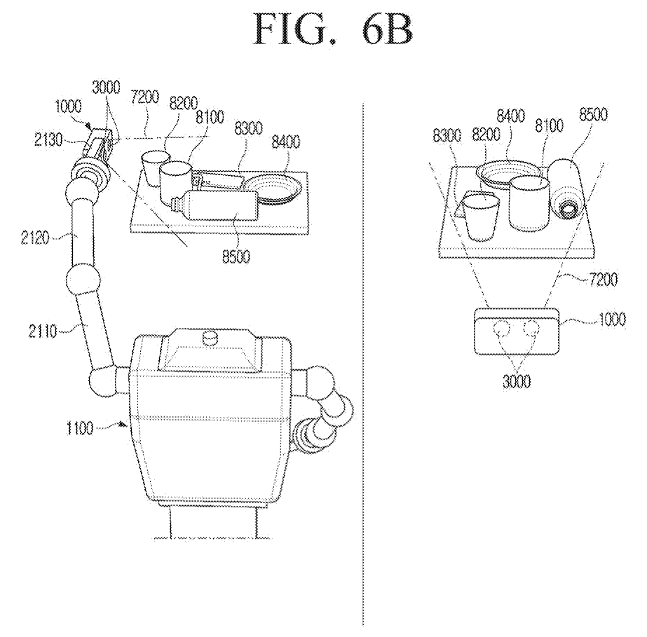

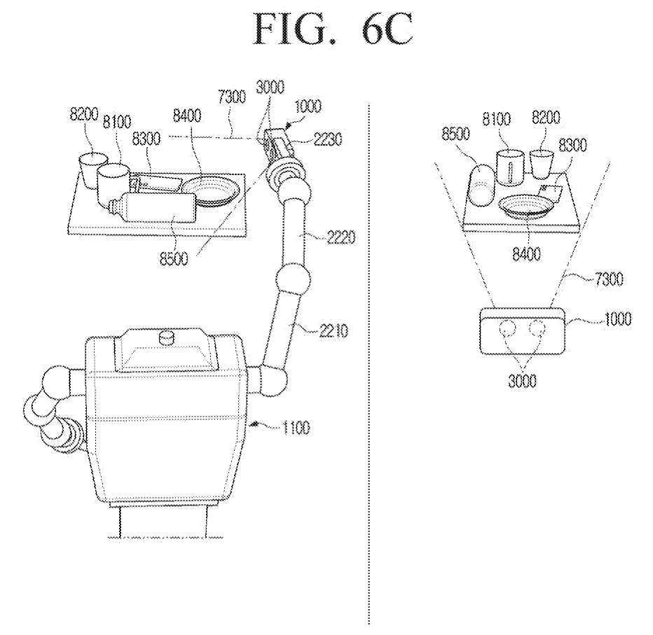

FIGS. 6A, 6B, and 6C are diagrams illustrating the robot apparatus 1 changing the position and sensing direction of the sensor 3000 according to at least one or more embodiments of the present disclosure.

In FIG. 6A, the robot apparatus 1 may identify the arrangement status of a target 8400 and surrounding objects 8100, 8200, 8300, and 8500 using the sensor 3000 disposed on the robot head 1000 from the front. The robot apparatus 1 may identify the arrangement status of the target 8400 and the surrounding objects 8100, 8200, 8300, and 8500 within the maximum sensing radius range 7100. The robot apparatus 1 may identify whether the target 8400 is occluded by the surrounding objects 8100, 8200, 8300, and 8500 based on a sensing value of the sensor 3000 disposed on the robot head 1000. Here, an occlusion refers to a situation in which the target 8400 is occluded by one or more of the surrounding objects 8100, 8200, 8300, and 8500 or is in contact therewith, thereby potentially hindering the operation of the robot apparatus 1. The robot apparatus 1 may estimate the area occluded by the shape in which the target 8400 is visible based on the sensing value of the sensor 3000. Thereafter, the robot apparatus 1 may determine the position of the sensor 3000 for occlusion resolution.

In FIG. 6B, the robot apparatus 1 may change the position and sensing direction of the robot head 1000 or the sensor 3000 by gripping and separating the robot head 1000 or the sensor 3000 of the main body 10 by controlling the first robot arm 2100 among the plurality of robot arms 2000. Similarly, in FIG. 6C, the robot apparatus 1 may change the position and sensing direction of the robot head 1000 or the sensor 3000 by gripping and separating the robot head 1000 or the sensor 3000 of the main body 10 by controlling the second robot arm 2200 among the plurality of robot arms 2000.

In FIGS. 6B and 6C, the robot apparatus 1 may identify the status of the target 8400 and the surrounding objects 8100, 8200, 8300, and 8500 based on a sensing value sensed by the robot head 1000 or sensor 3000 at the changed position. The robot apparatus 1 may identify the arrangement status of the target 8400 and surrounding objects 8100, 8200, 8300, and 8500 within the maximum sensing radius ranges 7200 and 7300. That is, the robot apparatus 1 may secure data on the status of the target 8400 and the surrounding objects 8100, 8200, 8300, and 8500 by separating and moving the robot head 1000 itself or the sensor 3000 mounted on the robot head 1000 through one of the plurality of robot arms 2000.

Specifically, in FIG. 6B, the robot apparatus 1 may place the position of the robot head 1000 or the sensor 3000 on the left side of the target 8400 and the surrounding objects 8100, 8200, 8300, and 8500 by gripping and separating the robot head 1000 or the sensor 3000 of the main body 10 by controlling the first robot arm 2100 among the plurality of robot arms 2000. The robot apparatus 1 may change the sensing direction of the robot head 1000 or sensor 3000 positioned on the left side of the target 8400 and the surrounding objects 8100, 8200, 8300, and 8500 to face the target 8400 and the surrounding objects 8100, 8200, 8300, and 8500. Thereafter, the robot apparatus 1 may identify the status of the target 8400 and the surrounding objects 8100, 8200, 8300, and 8500 based on the sensing value of the sensor 3000.

Similarly, in FIG. 6C, the robot apparatus 1 may place the robot head 1000 or the sensor 3000 on the right side of the target 8400 and the surrounding objects 8100, 8200, 8300, and 8500 by gripping and separating the robot head 1000 or the sensor 3000 of the main body 10 by controlling the second robot arm 2200 among the plurality of robot arms 2000. The robot apparatus 1 may change the sensing direction of the robot head 1000 or the sensor 3000 disposed on the right side of the target 8400 and the surrounding objects 8100, 8200, 8300, and 8500 to face the target 8400 and the surrounding objects 8100, 8200, 8300, and 8500. Thereafter, the robot apparatus 1 may identify the status of the target 8400 and the surrounding objects 8100, 8200, 8300, and 8500 based on a sensing value of the sensor 3000. However, the disclosure is not limited thereto, and the robot apparatus 1 may separate the robot head 1000 or the sensor 3000 through one of the plurality of robot arms 2000 and then move the robot head 1000 or the sensor 3000 to a position at which the various statuses of the target 8400 and the surrounding objects 8100, 8200, 8300, and 8500 may be identified, and change the sensing direction of the robot head 1000 or the sensor 3000 to face the target 8400 and the surrounding objects 8100, 8200, 8300, and 8500.

In FIG. 6A, based on the target 8400 being viewed from the front, an occlusion occurs due to the position of one or more of the surrounding objects 8100, 8200, 8300, and 8500. Accordingly, the robot apparatus 1 may identify that the target 8400 is occluded by the surrounding objects 8100, 8200, 8300, and 8500. Specifically, the robot may identify that the target 8400 is occluded by the fifth surrounding object 8500. In FIG. 6B, the robot head 1000 or the sensor 3000 is sensing the target 8400 and the surrounding objects 8100, 8200, 8300, and 8500 from the left. Based on being viewed from the left, the target 8400 may be identified as being occluded by the first surrounding object 8100. In FIG. 6C, the robot head 1000 or the sensor 3000 is sensing the target 8400 and the surrounding objects 8100, 8200, 8300, and 8500 from the right. Based on being viewed from the right, the target 8400 is not identified as being occluded by any of the surrounding objects. The robot apparatus 1 may synthesize these data to determine the status of the target 8400 and the surrounding objects 8100, 8200, 8300, and 8500, the position of a gripping point of the target 8400, whether there is an interference object on a gripping path of the target 8400, and whether an interference object is gripped and then moved.

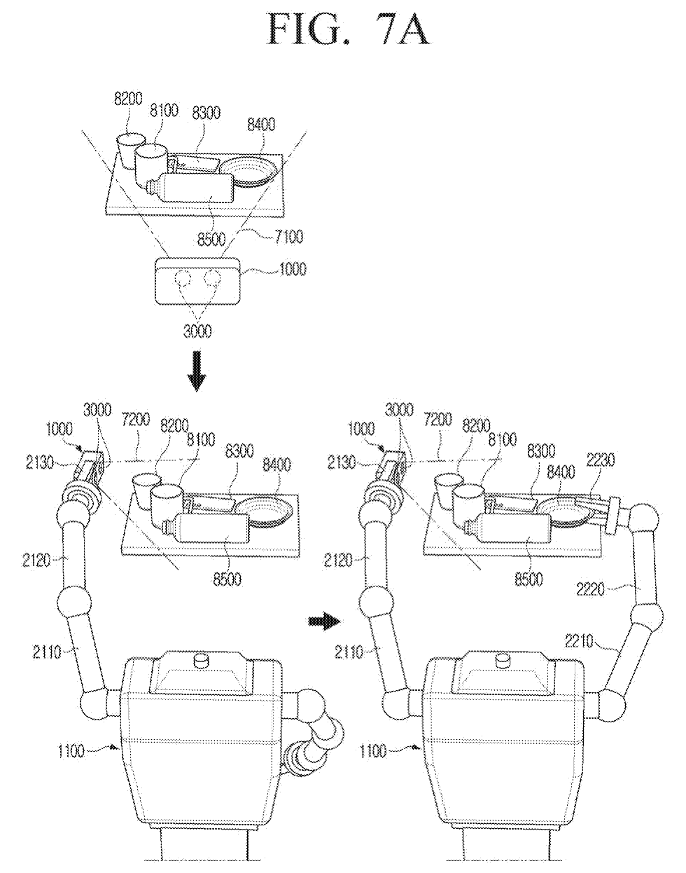

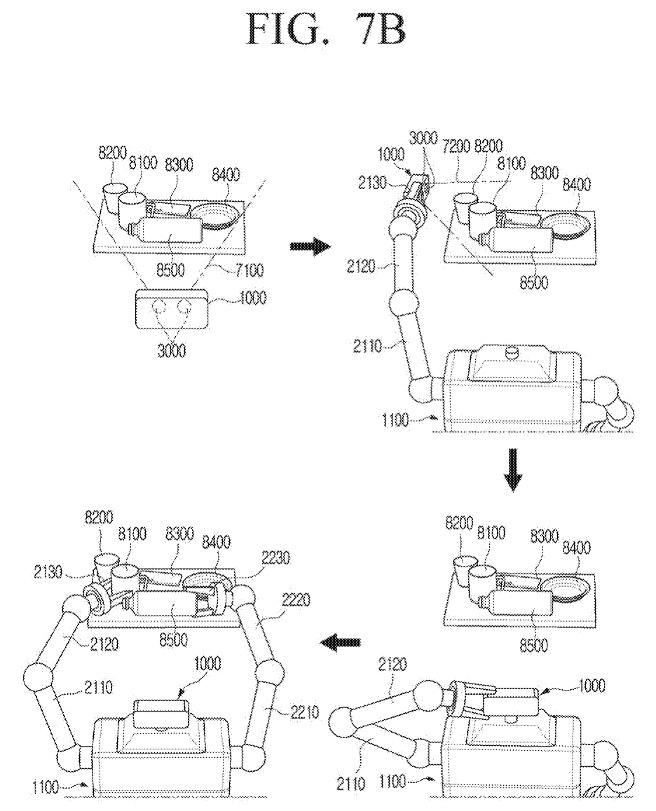

FIGS. 7A and 7B are diagrams illustrating a method for gripping the target 8400 according to at least one or more embodiments of the present disclosure.

In FIG. 7A, the robot apparatus 1 may identify the arrangement status of the target 8400 and the surrounding objects 8100, 8200, 8300, and 8500 using the sensor 3000 disposed on the robot head 1000 from the front. The robot apparatus 1 may identify the arrangement status of the target 8400 and the surrounding objects 8100, 8200, 8300, and 8500 within the maximum sensing radius range 7100. The robot apparatus 1 may identify whether the target 8400 is occluded by the surrounding objects 8100, 8200, 8300, and 8500 based on the sensing value of the sensor 3000 disposed on the robot head 1000. Here, an occlusion refers to a situation in which the target 8400 is occluded by one or more of the surrounding objects 8100, 8200, 8300, and 8500 or is in contact therewith, thereby potentially hindering the operation of the robot apparatus 1. The robot apparatus 1 may estimate the occluded area by the shape in which the target 8400 is visible based on the sensing value of the sensor 3000. Thereafter, the robot apparatus 1 may determine the position of the sensor 3000 for solving the occlusion.

In FIG. 7A, the robot apparatus 1 may change the position and sensing direction of the robot head 1000 or the sensor 3000 by gripping and separating the robot head 1000 or the sensor 3000 of the main body 10 by controlling the first robot arm 2100 among the plurality of robot arms 2000. Here, controlling the first robot arm 2100 refers to the same as controlling the plurality of first joints 2110 and 2120 and the first gripper 2130. Similarly, the robot apparatus 1 may change the position and sensing direction of the robot head 1000 or the sensor 3000 by gripping and separating the robot head 1000 or the sensor 3000 of the main body 10 by controlling the second robot arm 2200 among the plurality of robot arms 2000. Here, controlling the second robot arm 2200 refers to the same as controlling the plurality of second joints 2210 and 2220 and the second gripper 2130.

The robot apparatus 1 may identify the status of the target 8400 and the surrounding objects 8100, 8200, 8300, and 8500 based on the sensing value sensed by the robot head 1000 or the sensor 3000 at the changed position. That is, the robot apparatus 1 may secure the data of the status of the target 8400 and the surrounding objects 8100, 8200, 8300, and 8500 by separating and moving the robot head 1000 itself or the sensor 3000 mounted on the robot head 1000 through one of the plurality of robot arms 2000. Thereafter, the robot apparatus 1, while performing an operation of identifying the status of the target 8400 and the surrounding objects 8100, 8200, 8300, and 8500 at the changed position by the robot head 1000 or sensor 3000, may grip and move the target 8400 and the surrounding objects 8100, 8200, 8300, and 8500 through another one of the plurality of robot arms 2000. Specifically, while performing the operation of identifying the status of the target 8400 and the surrounding objects 8100, 8200, 8300, and 8500 at the changed position of the robot head 1000 or the sensor 3000, the robot apparatus 1 may grip and move the fifth surrounding object 8500, which is an interference object, through another one of the plurality of robot arms 2000 and may grip the target 8400.

In FIG. 7B, the robot apparatus 1 may change the position and sensing direction of the robot head 1000 or the sensor 3000 by gripping and separating the robot head 1000 or the sensor 3000 of the main body 10 by controlling the first robot arm 2100 of the plurality of robot arms 2000. Similarly, the robot apparatus 1 may change the position and sensing direction of the robot head 1000 or the sensor 3000 by gripping and separating the robot head 1000 or the sensor 3000 of the main body 10 by controlling the second robot arm 2200 among the plurality of robot arms 2000.

The robot apparatus 1 may identify the status of the target 8400 and the surrounding objects 8100, 8200, 8300, and 8500 based on the sensing value sensed by the robot head 1000 or the sensor 3000 at the changed position. That is, the robot apparatus 1 may secure data on the status of the target 8400 and the surrounding objects 8100, 8200, 8300, and 8500 by separating and moving the robot head 1000 itself or the sensor 3000 mounted on the robot head 1000 through one of the plurality of robot arms 2000. Thereafter, the robot apparatus 1 may return the robot head 1000 or the sensor 3000 at the changed position back to the original position. Thereafter, the robot apparatus 1 may grip and move the target 8400 and the surrounding objects 8100, 8200, 8300, and 8500 by controlling the first robot arm 2100 and the second robot arm 2200 of the plurality of robot arms 2000. That is, based on the status of the target 8400 and the surrounding objects 8100, 8200, 8300, and 8500 being identified based on the sensing value sensed by the sensor 3000 at the changed position, the robot apparatus 1 may mount the sensor 3000 on the main body 10 and control the first robot arm 2100 or the second robot arm 2200 to grip the target 8400. Here, the first robot arm 2100 and the second robot arm 2200 have the same meaning as controlling the plurality of first joints 2110 and 2120, the plurality of second joints 2210 and 2220, the first gripper 2130, and the second gripper 2230, respectively. Based on identifying that interference with the surrounding objects 8100, 8200, 8300, and 8500 will occur during the process of gripping the target 8400, the robot apparatus 1 may first grip and move the surrounding objects 8100, 8200, 8300, and 8500 using at least one of the plurality of robot arms 2000 and then grip the target 8400. In FIG. 7B, the robot apparatus 1 may grip and move the first surrounding object 8100 and the fifth surrounding object 8500 using the first robot arm 2100 and the second robot arm 2200 of the plurality of robot arms 2000 and then grip the target 8400 using one of the plurality of robot arms 2000.

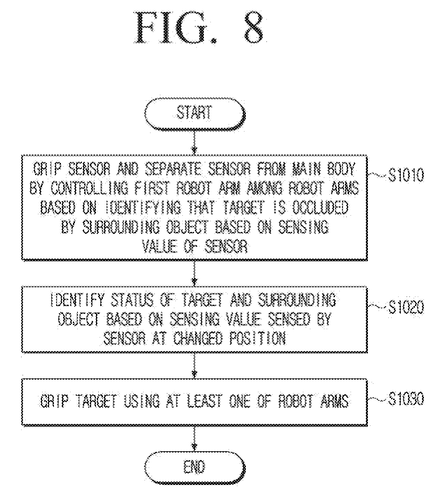

FIG. 8 is a flowchart illustrating a method of operating the robot apparatus 1 according to at least one or more embodiments of the present disclosure.

In FIG. 8, based on identifying that the target 8400 is occluded by one or more of the surrounding objects 8100, 8200, 8300, and 8500 based on the sensing value of the sensor 3000, the robot apparatus 1 may grip the sensor 3000 and separate the sensor 3000 from the main body 10 by controlling the first robot arm 2100 among the plurality of robot arms 2000 (S1010). Thereafter, the robot apparatus 1 may identify the status of the target 8400 and the surrounding objects 8100, 8200, 8300, and 8500 based on the sensing value sensed by the sensor 3000 at the changed position (S1020). Thereafter, the robot apparatus 1 may grip the target 8400 using at least one of the plurality of robot arms 2000 (S1030).

In the operation of gripping the target 8400 using at least one of the plurality of robot arms 2000, the robot apparatus 1 may grip the target 8400 by controlling the second robot arm 2200, which is another one of the plurality of robot arms 2000, while the first robot arm 2100 senses the target 8400.

Here, since the target 8400, the plurality of robot arms 2000, the sensor 3000, etc. have been described above, the description thereof is omitted.

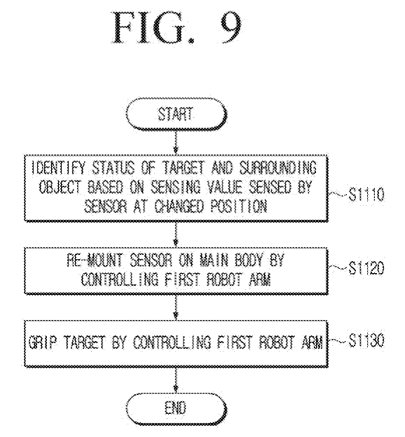

FIG. 9 is a flowchart illustrating a method of operating the robot apparatus 1 according to at least one or more embodiments of the present disclosure.

The robot apparatus 1 may identify the status of the target 8400 and the surrounding objects 8100, 8200, 8300, and 8500 based on the sensing value sensed by the sensor 3000 at the changed position (S1110). Thereafter, based on the status of the target 8400 and the surrounding objects 8100, 8200, 8300, and 8500 being identified based on the sensing value sensed by the sensor 3000 at the changed position, the robot apparatus 1 may control the first robot arm 2100 to re-mount the sensor 3000 on the main body 10 (S1120). Thereafter, the robot apparatus 1 may control the first robot arm 2100 to grip the target 8400 (S1130).

Here, based on identifying that interference with surrounding objects 8100, 8200, 8300, and 8500 will occur during the gripping process of the target 8400, the robot apparatus 1 may first grip and move the surrounding objects 8100, 8200, 8300, and 8500 using at least one of the plurality of robot arms 2000, and then grip the target 8400.

Here, since the detailed description of the target 8400 and the surrounding objects 8100, 8200, 8300, and 8500 has been given above, the description thereof is omitted.

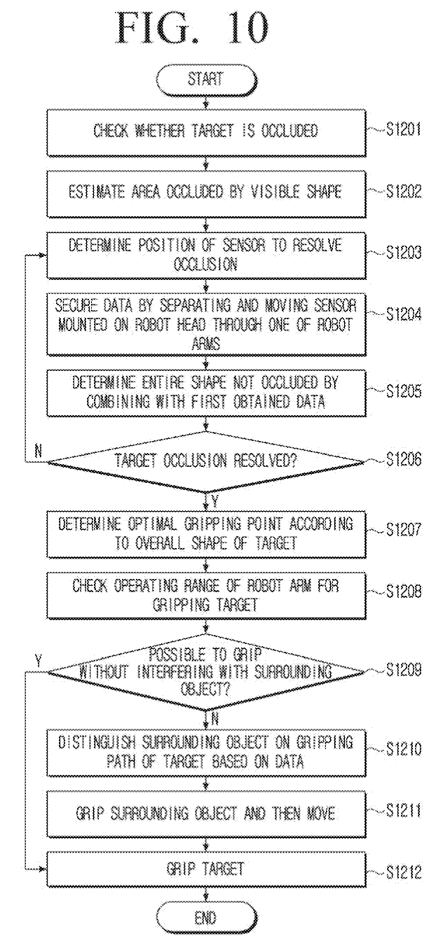

FIG. 10 is a flowchart illustrating a method of operating the robot apparatus 1 according to at least one or more embodiments of the present disclosure.

The robot apparatus 1 may identify whether the target 8400 is occluded based on the sensing value of the sensor 3000 (S1201). Thereafter, the robot apparatus 1 may estimate an occluded area of the target 8400 in a visible shape based on the sensing value of the sensor 3000 (S1202). Thereafter, the robot apparatus 1 may determine the position of the sensor 3000 for resolving the occlusion that the target 8400 is occluded (S1203). The robot apparatus 1 may secure data on the status of the target 8400 and the surrounding objects 8100, 8200, 8300, and 8500 by separating and moving the robot head 1000 itself or the sensor 3000 mounted on the robot head 1000 through one of the plurality of robot arms 2000 (S1204). Thereafter, the robot apparatus 1 may determine the entire shape of the target 8400 and the surrounding objects 8100, 8200, 8300, and 8500 that are not occluded by combining the data on the status of the target 8400 and the surrounding objects 8100, 8200, 8300, and 8500 obtained from the front based on the sensing value of the sensor 3000 at the changed position (S1205). Thereafter, the robot apparatus 1 may determine whether the occlusion of the target 8400 may be resolved based on the obtained data (S1206). Here, based on the occlusion of the target 8400 that cannot be resolved based on the obtained data, the robot apparatus 1 may start again from the operation of determining the position of the sensor 3000 for resolving the occlusion that the target 8400 is occluded. Based on the occlusion of the target 8400 that may be resolved based on the acquired data, the robot apparatus 1 may determine an optimal gripping point according to the overall shape of the target 8400 (S1207).

Thereafter, the robot apparatus 1 may check an operating range of at least one robot arm among the plurality of robot arms 2000 for gripping the target 8400 (S1208). Thereafter, the robot apparatus 1 may determine whether it is possible to grip the target 8400 without interfering with the surrounding objects 8100, 8200, 8300, and 8500 (S1209). Here, based on that it is possible to grip the target 8400 without interfering with the surrounding objects 8100, 8200, 8300, and 8500, the robot apparatus 1 may grip the target 8400. Based on that it is impossible to grip the target 8400 without interfering with the surrounding objects 8100, 8200, 8300, and 8500, the robot apparatus 1 may distinguish the surrounding objects 8100, 8200, 8300, and 8500 on a gripping path of the target 8400 based on the acquired data (S1210). Thereafter, the robot apparatus 1 may grip the surrounding objects 8100, 8200, 8300, and 8500 and then move them to a position other than the gripping path of the target 8400 by controlling at least one of the plurality of robot arms 2000 (S1211). Thereafter, the robot apparatus 1 may grip the target 8400 (S1212).

Each of the components described in this document may include one or more components, and the names of the corresponding components may vary depending on the type of electronic device.

One or more embodiments of the present disclosure have been individually described but the embodiments may not necessarily be implemented alone and components and operations of the respective embodiments may be combined with at least any other embodiment so as to be implemented.

Although the embodiments have been illustrated and described hereinabove, the present disclosure is not limited to the above-mentioned specific embodiments, but may be variously modified by those skilled in the art without departing from the scope and spirit of the present disclosure as disclosed in the accompanying claims. These modifications should also be understood to fall within the scope of the present disclosure.

What is claimed is:

1. A robot apparatus comprising:
a main body;
a plurality of robot arms on the main body;
a sensor detachably connected to the main body;
memory storing at least one instruction; and
at least one processor configured to execute the at least one instruction,
wherein the at least one instruction, when executed by the at least one processor individually or collectively, causes the robot apparatus to:
identify a target based on a sensing value of the sensor;
perform a task related to the target using at least one of the plurality of robot arms;
based on identifying that the target is occluded by an object, control a first robot arm among the plurality of robot arms to grip and separate the sensor from the main body and to change a position and a sensing direction of the sensor; and
identify a status of the target and the object based on a sensing value of the sensor obtained at the changed position.

2. The robot apparatus of claim 1, wherein the at least one instruction, when executed by the at least one processor individually or collectively, further causes the robot apparatus to control a second robot arm, among the plurality of robot arms, to grip the target based on the status of the target and the object.

3. The robot apparatus of claim 1, wherein the at least one instruction, when executed by the at least one processor individually or collectively, further causes the robot apparatus to:
mount the sensor on the main body; and
control the first robot arm to grip the target based on the status of the target and the object.

4. The robot apparatus of claim 2, wherein the at least one instruction, when executed by the at least one processor individually or collectively, further causes the robot apparatus to:
based on the object interfering with an ability of the robot apparatus to grip the target, grip and move the object using at least one of the plurality of robot arms before gripping the target.

5. The robot apparatus of claim 3, wherein the at least one instruction, when executed by the at least one processor individually or collectively, further causes the robot apparatus to:
based on the object interfering with an ability of the robot apparatus to grip the target, grip and move the object using at least one of the plurality of robot arms before gripping the target.

6. The robot apparatus of claim 1, wherein the main body comprises:
a robot body;
a driver below the robot body; and
a robot head above the robot body, and
wherein the plurality of robot arms are coupled to sides of the robot body, and the sensor is on the robot head.

7. The robot apparatus of claim 6, wherein the robot head further comprises:
a connection portion configured to connect to the sensor; and
a reel cable connected to the sensor, and
wherein the reel cable is extendable based on the sensor being separated from the main body.

8. The robot apparatus of claim 6, wherein the robot head comprises a first interface configured to connect to the sensor,
wherein an end effector of at least one first robot arm among the plurality of robot arms comprises a second interface configured to connect to the sensor, and
wherein the at least one instruction, when executed by the at least one processor individually or collectively, further causes the robot apparatus to, based on the occlusion being identified while the sensor is coupled to the robot head through the first interface, control the first robot arm to separate the sensor from the first interface and to mount the sensor on the second interface.

9. The robot apparatus of claim 1, wherein the at least one instruction, when executed by the at least one processor individually or collectively, further causes the robot apparatus to:
control the first robot arm to sequentially move the sensor to a plurality of positions facing the target, and
identify a characteristic of the target and a characteristic of the object by combining sensing values obtained at the plurality of positions.

10. A method of controlling a robot apparatus, the method comprising:
based on identifying that a target is occluded by an object, controlling a first robot arm among a plurality of robot arms of the robot apparatus to grip a sensor of the robot apparatus and to separate the sensor from a main body of the robot apparatus;
moving the first robot arm to change a position and a sensing direction of the sensor;
identifying a status of the target and the object based on a sensing value, wherein the sensing value is obtained by the sensor at a changed position; and
gripping the target using at least one of the plurality of robot arms.

11. The method of claim 10, wherein the gripping the target using at least one of the plurality of robot arms comprises:
controlling a second robot arm, among the plurality of robot arms, to grip the target while the sensor is gripped by the first robot arm and is sensing the target.

12. The method of claim 10, wherein the gripping the target using at least one of the plurality of robot arms comprises:
based on the status of the target and the object being identified based on the sensing value sensed by the sensor at the changed position, controlling the first robot arm to re-mount the sensor on the main body; and
controlling the first robot arm to grip the target.

13. The method of claim 11, further comprising:
based on the object interfering with an ability of the robot apparatus to grip the target, gripping and moving the object using at least one of the plurality of robot arms before gripping the target.

14. The method of claim 12, further comprising:
based on the object interfering with an ability of the robot apparatus to grip the target, gripping and moving the object using at least one of the plurality of robot arms before gripping the target.

15. The method of claim 10, wherein the controlling the first robot arm among the plurality of robot arms to grip the sensor and to separate the sensor from the main body comprises, based on identifying that the target is occluded while the sensor is connected to a first interface of the robot head of the robot apparatus, controlling the first robot arm to separate the sensor from the first interface on a robot head of robot apparatus and to connect the sensor to a second interface on an end effector of the first robot arm.

16. The method of claim 10, wherein the moving the first robot arm to change the position and the sensing direction of the sensor comprises controlling the first robot arm to sequentially move the sensor to a plurality of positions facing the target.

17. The method of claim 16, wherein the identifying the status of the target and the object comprises identifying a characteristic of the target and a characteristic of the object by combining the sensing values sensed at the plurality of positions and directions.

18. A non-transitory computer readable medium having instructions stored therein, which when executed by at least one processor cause the at least one processor to execute a method of controlling a robot apparatus, the method comprising:
based on identifying that a target is occluded by an object, controlling a first robot arm among a plurality of robot arms of the robot apparatus to grip a sensor of the robot apparatus and to separate the sensor from a main body of the robot apparatus;
moving the first robot arm to change a position and a sensing direction of the sensor;
identifying a status of the target and the object based on a sensing value, wherein the sensing value is obtained by the sensor at a changed position; and
gripping the target using at least one of the plurality of robot arms.

19. The non-transitory computer readable medium of claim 18, wherein the gripping the target using at least one of the plurality of robot arms comprises:
controlling a second robot arm, among the plurality of robot arms, to grip the target while the sensor is gripped by the first robot arm and is sensing the target.

20. The non-transitory computer readable medium of claim 18, wherein the gripping the target using at least one of the plurality of robot arms comprises:
based on the status of the target and the object being identified based on the sensing value sensed by the sensor at the changed position, controlling the first robot arm to re-mount the sensor on the main body; and
controlling the first robot arm to grip the target.
